(19) United States
(12) Patent Application Publication
(10) Pub. No.: US 2010/0043418 A1
(43) Pub. Date: Feb. 25, 2010

(54) HYDRAULIC SYSTEM AND METHOD FOR CONTROL

(75) Inventors: Michael T. Verkuilen, Germantown Hills, IL (US); Eko A. Prasetiawan, Holly Springs, NC (US); Jeffrey L. Kuehn, Metamora, IL (US); Shoji Tozawa, Hyogo-Ken (JP); Srinivas Kowta, Tamil Nadu (IN)

Correspondence Address: Caterpillar Inc.;Intellectual Property Dept., AH 9510, 100 N.E. Adams Street, PEORIA, IL, 61629-9510, US

(73) Assignee: Caterpillar Inc., Peoria, IL (US)

(21) Appl. No.: 12/575,716

(22) Filed: Oct. 8, 2009

Related U.S. Application Data
(63) Continuation-in-part of application No. 11/238,962, filed on Sep. 30, 2005, now Pat. No. 7,614,336.

(51) Int. Cl. F15B 13/00

(52) U.S. Cl. 60/327; 60/368

(57) ABSTRACT

A hydraulic system is disclosed having at least two hydraulic circuits. The disclosed system compares pressures between the hydraulic circuits and alters valve commands of the circuit associated with higher pressures in order to reduce overall system pressure.

### RELATED APPLICATIONS

This patent application is a continuation-in-part of U.S. patent applicaion Ser. No. 11/238,962, filed Sep. 30, 2005, which is hereby incorporated by reference.

### TECHNICAL FIELD

The present disclosure relates generally to a hydraulic system, and more particularly, to a hydraulic system having multiple circuits.

### BACKGROUND

Hydraulic systems are often used to control the operation of hydraulic actuators of machines. These hydraulic systems typically include valves, arranged within hydraulic circuits, fluidly connected between the actuators and pumps. These valves may each be configured to control a flow rate and direction of pressurized fluid to or from respective chambers within the actuators.

In some instances, multiple actuators may be connected to a common pump. During actuation of multiple actuators one actuator may require a significantly higher pressure from the pump than other actuators. Actuation of one such actuator may also create undesirable pressure or flow conditions in other parts of the system. The pressure and flow of the fluid provided to each actuator can be controlled, in part, by valves between the pump and the actuator. It is generally desirable to control the valves in a way that improves the efficiency of the system.

One method of reducing pressure fluctuations in hydraulic systems is described in U.S. Pat. No. 5,878,647 (“the '647 patent”) issued to Wilke et al. While the hydraulic circuit described in the '647 patent may reduce pressure fluctuations, it may also result in unnecessarily high system pressure.

### SUMMARY OF THE INVENTION

A hydraulic system is disclosed having a source of pressurized fluid, and a first hydraulic circuit configured to receive pressurized fluid from the source. The first hydraulic circuit is provided with a first valve and a first actuator, the first valve being disposed between the source and the first actuator, and the first actuator operating at a first pressure. A second hydraulic circuit is also provided and configured to receive pressurized fluid from the source. The second hydraulic circuit includes a second valve and a second actuator, the second valve being disposed between the source and the second actuator, and the second actuator operating at a second pressure. The hydraulic system also includes a controller configured to receive a command input, and based on the command input, determine a first initial flow passing command for the first valve and a second initial flow passing command for the second valve. The controller further determines which of the first pressure and the second pressure is a higher pressure and alters the initial flow passing command for a high pressure valve, the high pressure valve being the one of the first valve and the second valve corresponding to the higher pressure.

### BRIEF DESCRIPTION OF THE DRAWINGS

FIG. 1 is a diagrammatic illustration of a disclosed machine; and

FIG. 2 is a schematic illustration of a disclosed hydraulic system.

### DETAILED DESCRIPTION

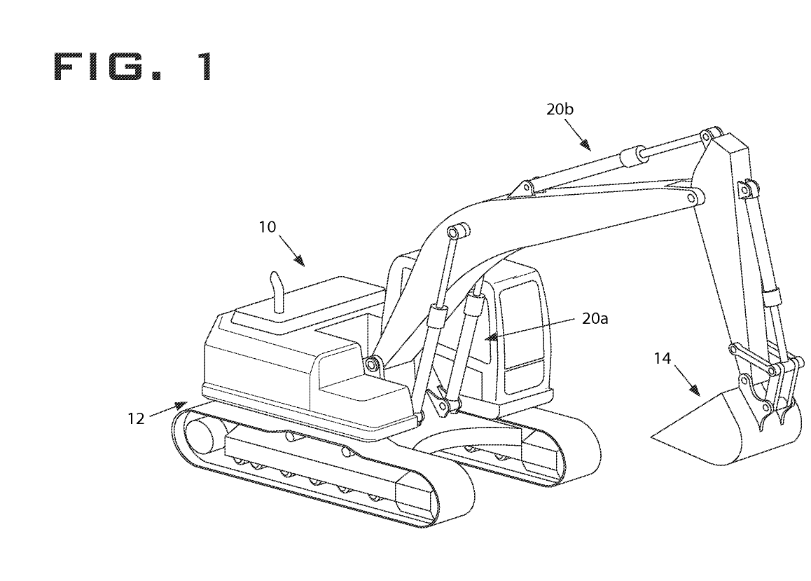

FIG. 1 illustrates an exemplary machine 10. Machine 10 may be a fixed or mobile machine that performs some type of operation associated with an industry such as mining, construction, farming, or any other industry known in the art. For example, machine 10 may be an earth-moving machine such as a dozer, a loader, a backhoe, an excavator, a motor grader, a dump truck, or any other earth moving machine. Machine 10 may also include a generator set, a pump, a marine vessel, or any other suitable operation-performing machine. Machine 10 may include a frame 12, an implement 14, and hydraulic actuators 20a, 20b connected between implement 14 and frame 12. Alternatively, hydraulic actuator 20a may be connected between implement 14 and frame 12 while hydraulic actuator 20b may be connected between a separate implement (not shown) and frame. Machine 10 may also include more than the two actuators 20a, 20b specifically discussed herein.

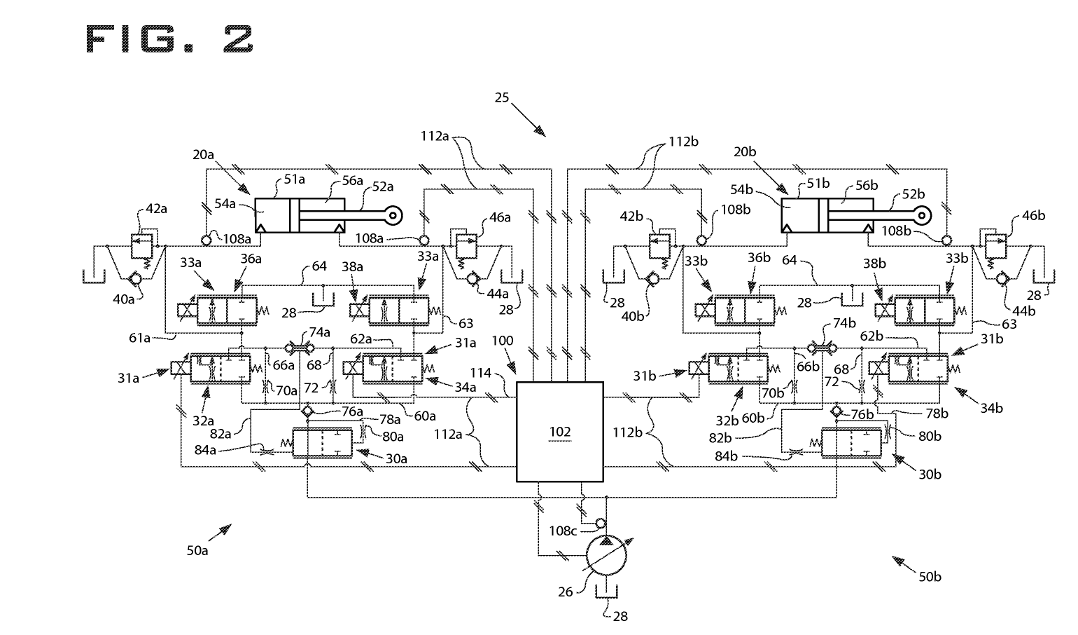

As illustrated in FIG. 2, machine 10 may further include a hydraulic system 25 configured to affect movement of hydraulic actuators 20a, 20b so as to move, for example implement 14. Hydraulic system 25 may further include two hydraulic circuits 50a, 50b configured to control the operation of hydraulic actuators 20a, 20b, respectively.

Hydraulic system 25 may further include a source 26 of pressurized fluid and a tank 28. Hydraulic circuits 50a, 50b, may each include a pressure compensating valve 30a, 30b. Each hydraulic circuit 50a, 50b may further include two supply valves 31a, 31b: a head-end supply valve 32a, 32b and a rod-end supply valve 34a, 34b; as well as two drain valves 33a, 33b: a head-end drain valve 36a, 36b, and a rod-end drain valve 38a, 38b. Each hydraulic circuit may also include a head-end make-up valve 40a, 40b, a head-end relief valve 42a, 42b, a rod-end make-up valve 44a, 44b, and a rod-end relief valve 46a, 46b. It is contemplated that hydraulic system 25 may include additional and/or different components such as, for example, a temperature sensor, a position sensor, an accumulator, and/or other components known in the art.

Hydraulic actuators 20a, 20b may include a piston-cylinder arrangement, a hydraulic motor, and/or any other known hydraulic actuator having one or more fluid chambers therein. According to an embodiment of this disclosure, hydraulic actuators 20a, 20b may include a tube 51a, 51b and a piston assembly 52a, 52b. Hydraulic actuators 20a, 20b may also include a head-end chamber 54a, 54b and a rod-end chamber 56a, 56b separated by piston assembly 52a, 52b.

Source 26 may be configured to produce a flow of pressurized fluid and may include a variable displacement pump such as, for example, a swashplate pump, a variable pitch propeller pump, and/or other sources of pressurized fluid known in the art. Source 26 may be controlled by a control system 100 and may be drivably connected to a power source (not shown) of machine 10 by, for example, a countershaft (not shown), a belt (not shown), an electrical circuit (not shown), and/or in any other suitable manner. Source 26 may be disposed between tank 28 and hydraulic actuators 20a, 20b and may be configured to be controlled by control system 100.

Pressure compensating valves 30a, 30b may be proportional control valves disposed between source 26 and an upstream supply passageway 60a, 60b, respectively, and may be configured to control a pressure of the fluid supplied to upstream supply passageway 60a, 60b, respectively. Pressure compensating valves 30a, 30b may include a proportional valve element that may be spring and hydraulically biased toward a flow passing position and hydraulically biased toward a flow blocking position.

Pressure compensating valves 30a, 30b may be movable toward the flow blocking position by a fluid directed via a fluid passageway 78a, 78b from a point between pressure compensating valve 30a, 30b and upstream supply passageway 60a, 60b. A restrictive orifice 80a, 80b may be disposed within fluid passageway 78a, 78b to minimize pressure and/or flow oscillations within fluid passageway 78a, 78b. Pressure compensating valve 30a, 30b may be movable toward the flow passing position by the combined forces of a spring and a fluid directed via a fluid passageway 82a, 82b from a shuttle valve 74a, 74b. A restrictive orifice 84a, 84b may be disposed within fluid passageway 82a, 82b to minimize pressure and/or flow oscillations within fluid passageway 82a, 82b. It is contemplated that the proportional valve element of pressure compensating valve 30a, 30b may alternately be spring biased toward a flow blocking position, that the fluid from fluid passageway 82a, 82b may alternately bias the valve element of pressure compensating valve 30a, 30b toward the flow blocking position, and/or that the fluid from passageway 78a, 78b may alternately move the proportional valve element of pressure compensating valve 30a, 30b toward the flow passing position. It is also contemplated that pressure compensating valve 30a, 30b may alternately be located downstream of supply valves 31a, 31b, or in any other suitable location. It is further contemplated that restrictive orifices 80a, 80b, and 84a, 84b may be omitted, if desired.

Supply valves 31a, 31b may be disposed between source 26 and hydraulic actuator 20a, 20b, respectively, and may be configured to regulate a flow of pressurized fluid to actuators 20a, 20b. Specifically, head-end supply valves 32a, 32b may be disposed between source 26 and head-end chamber 54a, 54b, and rod-end supply valves 34a, 34b may be disposed between source and rod-end chambers 56a, 56b, respectively. Depending on the direction of actuation of the actuator 20a, 20b, one of head-end supply valve 32a, 32b or rod-end supply valve 34a, 34b will provide the supply of pressurized fluid to the actuator 20a, 20b for its respective circuit 50a, 50b. For example, if pressurized fluid is provided to the head end 54a of actuator 20a in circuit 50a, head-end supply valve 32a would be the acting supply valve 31a in circuit 50a.

Supply valves 31a, 31b may each include a proportional valve element that may be spring biased and solenoid actuated to move the valve element to any of a plurality of positions from a first position in which fluid flow may be substantially blocked from flowing toward actuator 20a, 20b to a second position in which a maximum fluid flow may be allowed toward actuator 20a, 20b. Additionally, the proportional valve elements of supply valves 31a, 31b may be controlled by control system 100 to vary the size of a flow area through which the pressurized fluid may flow.

Drain valves 33a, 33b may be disposed between hydraulic actuator 20a, 20b and tank 28 and may be configured to regulate a flow of pressurized fluid from head-end chamber 54a, 54b, or rod-end chamber 56a, 56b, depending on the direction of actuation. Specifically, head-end drain valves 36a, 36b and rod-end drain valves 38a, 38b may each include a two-position valve element that may be spring biased and solenoid actuated between a first position at which fluid may be allowed to flow from head-end chamber 54a, 54b or rod-end chamber 56a, 56b, depending on the direction of actuation, and a second position at which fluid may be substantially blocked from flowing from head-end chamber 54a, 54b or rod-end chamber 56a, 56b. Supply valves 31a, 31b and drain valves 33a, 33b may be fluidly interconnected as illustrated in FIG. 2.

Shuttle valve 74a, 74b may be disposed within downstream system signal passageway 62a, 62b. Shuttle valve 74a, 74b may be configured to fluidly connect the one of head-end supply valve 32a, 32b and rod-end supply valve 34a, 34b having a lower fluid pressure to pressure compensating valve 30a, 30b. In this manner, shuttle valve 74a, 74b may resolve pressure signals from head-end supply valve 32a, 32b and rod-end supply valve 34a, 34b to allow the lower outlet pressure of the two valves to affect movement of pressure compensating valve 30a, 30b via fluid passageway 82a, 82b.

Hydraulic system 24 may include additional components to control fluid pressures and/or flows within hydraulic system 24. Specifically, hydraulic system 24 may include pressure balancing passageways 66a, 66b configured to control fluid pressures and/or flows within hydraulic system 24. Pressure balancing passageways 66a, 66b may fluidly connect upstream supply passageway 60a, 60b and downstream system signal passageway 62a, 62b. Pressure balancing passageways 66a, 66b may include restrictive orifices 70a, 70b, to minimize pressure and/or flow oscillations within fluid passageways 66a, 66b. Hydraulic system 24 may also include a check valve 76a, 76b disposed between pressure compensating valve 30a, 30b and upstream supply passageway 60a, 60b and may be configured to block pressurized fluid from flowing from upstream supply passageway 60a, 60b to pressure compensating valve 30a, 30b.

Control system 100 may be configured to control the operation of head-end supply valves 31a, 31b and drain valves 33a, 33b source 26. Control system 100 may include a controller 102 configured to receive pressure signals from pressure sensors 108a, 108b, 108c via communication lines 112a, 112b. Controller 100 may also be configured to deliver control signals to supply valves 31a, 31b, drain valves 33a, 33b, and source 26 via communication lines 112a, 112b. It is contemplated that the pressure and control signals may each be any conventional signal, such as, for example, a pulse, a voltage level, a magnetic field, a sound or light wave, and/or another signal format.

Controller 102 may be configured to control hydraulic system 24 in response to the pressure signals received from pressure sensors 108a, 108b, 108c. Controller 102 may be configured to perform one or more algorithms to determine appropriate output signals to control the movement of the valve elements of, and thus the amount of flow directed through, supply valves 31a, 31b and drain valves 33a, 33b and to control the output, e.g., displacement and/or input speed, of source 26. Controller 102 may determine the appropriate control signals by, for example, predetermined equations, look-up tables, and/or maps. It is further contemplated that controller 102 may control the operation of other components within hydraulic system 24.

In operation, source 26 provides pressurized fluid to either head-end chamber 54a, 54b or rod-end chamber 56a, 56b of one or more actuators 20a, 20b, depending on the direction of actuation. Flow of fluid to the actuator 20a, 20b may be controlled in part by control of source 26. For example, source 26 may be a variable displacement axial piston pump, in which case the rate of flow from source 26 may be controlled by the angle of the swashplate and/or the speed of the pump.

Flow of pressurized fluid from the source 26 to actuator 20a, 20b may also be controlled in part by the respective supply valve 31a, 31b. By altering the flow passing area of supply valve 31a, 31b, the flow of fluid to the respective actuator 20a, 20b, and the pressure drop over supply valve 31a, 31b may be controlled.

When multiple circuits 50a, 50b simultaneously request flow to actuate multiple actuators 20a, 20b, one circuit, e.g. circuit 50a, may require fluid at a higher pressure than the other circuit, e.g. circuit 50b. In this situation, controller 102 may determine which circuit 50a, 50b is at a higher pressure. Controller 102 may then determine the available flow from the source 26. The flow available from source 26 may be limited, for example, by a maximum flow rate of source 26, in which case available flow could depend on, among other things, a maximum speed and displacement of source 26. Alternatively, the flow available from source could be limited by available power, in which case available flow could depend on, among other things, an output pressure from source 26 and the power available to source 26.

During multi-function operations, controller 102 may apportion available flow from source 26 between each circuit 50a, 50b. For example, controller 102 may control multiple supply valves 31a, 31b, to be actuated to flow passing positions to direct pressurized fluid to respective chambers, e.g., head-end chambers 54a, 54b or rod-end chambers 56a, 56b, of the multiple hydraulic actuators 20a, 20b. For example, controller 102 may include logic that relates a set of inputs, such as an operator input or inputs, to a initial flow passing position of supply valves 31a, 31b, and/or drain valves 33a, 33b. The logic may include a look-up table, an algorithm, priority schemes or other methods for relating inputs to desired flow passing positions of supply valves 31a, 31b as may be known in the art.

Controller 102 may receive multiple pressure signals from pressure sensors 108a, 108b associated with the multiple circuits 50a, 50b and pressure sensor 108c associated with source 26. Controller 102 may then compare pressure signals between the hydraulic circuits 50a, 50b to determine which circuit 50a, 50b, or more specifically which actuator 20a, 20b, is operating at a higher pressure. For example, if pressurized fluid is provided to head-end chamber 54a and head-end chamber 54b, controller 102 may compare a pressure downstream of head-end supply valve 32a with a pressure downstream of head-end supply valve 32b. If the pressure downstream of head-end supply valve 32a is greater than the pressure downstream of head-end supply valve 32b, controller 102 may provide a high-pressure altered command, such that the flow passing position of supply valve 32a is larger, i.e. passes fluid with less restriction, than the initial command would have caused. The alteration of the initial command provided to such high-pressure supply valve 31a, 31b, e.g. head-end supply valve 32a, may cause the flow passing area of the respective valve to be increased by a percentage, by a fixed displacement, or by any other method of causing an increase in flow passing area.

If the pressure difference between the high pressure supply valve 31a, 31b, e.g. head-end supply valve 32a, and the low pressure supply valve 31a, 31b, e.g. head-end supply valve 32b, is below a predetermined value, controller 102 may provide a high-pressure altered command to both the high pressure supply valve 31a, 31b, and the low pressure supply valve 31a, 31b, such that the flow passing area of the low pressure supply valve 31a, 31b is increased in a manner similar to the increase in the flow passing area of the high pressure supply-valve 31a, 31b. In doing so, a smooth transition may be facilitated when a low pressure supply-valve 31a, 31b becomes the high-pressure supply valve 31a, 31b, and vice versa.

A high-pressure altered command may be provided to both supply valves 31a, 31b during a period of time in which the pressure differential between the supply valves 31a, 31b is below a predetermined pressure value. Alternatively, a high-pressure altered command may be provided to both supply valves 31a, 31b for a predetermined period of time after the pressure differential drops below a predetermined value. In yet another alternative, the high-pressure altered command may be provided to both supply valves 31a, 31b for the greater of a period of time in which the pressure differential between the supply valves 31a, 31b is below a predetermined value and a predetermined period of time after the pressure differential drops below a predetermined value.

### INDUSTRIAL APPLICABILITY

The disclosed hydraulic system may be applicable to increase the efficiency of a machine 10. By altering the command to the high-pressure supply valve 31a, 31b, the overall pressure demand on source 26 may be reduced. For example, considering that head-end supply valve 32a may be, for a desired operation, the high-pressure supply valve, pressure compensating valve 30a may maintain a constant pressure drop between source 26 and first hydraulic actuator 18. By altering head-end supply valve 32a, the pressure differential between upstream supply passageway 60a and first chamber passageway 61a may be reduced. Consequently, this lower pressure differential may then affect the balance of the proportional valve element of pressure compensating valve 30a to a more open position. As such, both the pressure drop over the compensating valve 30a and the supply valve 31a may be reduced, and less pressure may be required from source 26. As such, a reduction in the required output of the power source drivably connected to source 26 may be realized or the displacement of source 26 may be increased to realize an increased flow of pressurized fluid.

It will be apparent to those skilled in the art that various modifications and variations can be made to the disclosed hydraulic system. Other embodiments will be apparent to those skilled in the art from consideration of the specification and practice of the disclosed hydraulic system. It is intended that the specification and examples be considered as exemplary only, with a true scope being indicated by the following claims and their equivalents.

What is claimed is:

1. A hydraulic system comprising:
a source of pressurized fluid;
a first hydraulic circuit configured to receive pressurized fluid from the source and having a first valve and a first actuator, the first valve being disposed between the source and the first actuator, and the first actuator operating at a first pressure;
a second hydraulic circuit configured to receive pressurized fluid from the source and having a second valve and a second actuator, the second valve being disposed between the source and the second actuator, and the second actuator operating at a second pressure; and
a controller configured to:
receive a command input;
based on the command input, determine a first initial flow passing command for the first valve and a second initial flow passing command for the second valve;
determine which of the first pressure and the second pressure is a higher pressure; and
alter the initial flow passing command for a high pressure valve, the high pressure valve being the one of the first valve and the second valve corresponding to the higher pressure.

2. The hydraulic system of claim 1, wherein the alteration of the initial flow passing command of the high pressure valve causes a restriction of fluid flow through the high pressure valve to be reduced.

3. The hydraulic system of claim 1, wherein the controller is further configured to provide the respective initial flow passing command to a low pressure valve, the low pressure valve being the one of the first valve and the second valve corresponding to the lower of the first pressure and the second pressure.

4. The hydraulic system of claim 3, wherein the controller is further configured to determine a pressure differential between the first pressure and the second pressure.

5. The hydraulic system of claim 4, wherein the controller is further configured to:
provide the initial flow passing command to the low pressure valve when the pressure differential is greater than a predetermined pressure value; and
alter the initial flow passing command for the low pressure valve when the pressure differential is less that the predetermined pressure value.

6. The hydraulic system of claim 1, wherein the first pressure is taken between the first valve and the first actuator.

7. The hydraulic system of claim 6, wherein the second pressure is taken between the second valve and the second actuator.

8. The hydraulic system of claim 1, wherein the source of pressurized fluid is a variable displacement pump.

9. The hydraulic system of claim 1, further including a pressure compensating valve disposed between the source and the first valve, the pressure compensating valve being configured to regulate the flow of pressurized fluid directed from the source to the first valve.

10. The hydraulic system of claim 5, wherein the controller is configured to alter the initial flow passing command for both the low pressure valve and the high pressure valve for the greater of a predetermined period of time and a period of time during which the pressure differential is less than the predetermined pressure value.

11. A machine comprising:
a frame;
an implement;
a source of pressurized fluid;
a first hydraulic circuit configured to receive pressurized fluid from the source and having a first valve and a first actuator disposed between the frame and the implement, the first valve being disposed between the source and the first actuator, the first actuator operating at a first pressure;
a second hydraulic circuit configured to receive pressurized fluid from the source and having a second valve and a second actuator, the second valve being disposed between the source and the second actuator, and the second actuator operating at a second pressure; and
a controller configured to:
receive an operator input;
based on the operator input, determine a first initial flow command for the first valve and a second initial flow command for the second valve;
determine which of the first pressure and the second pressure is a higher pressure; and
alter the initial flow passing command for a high pressure valve, the high pressure valve being the one of the first valve and the second valve corresponding to the higher pressure.

12. The hydraulic system of claim 11, wherein the alteration of the initial flow passing command of the high pressure valve causes a restriction of fluid flow through the high pressure valve to be reduced.

13. The hydraulic system of claim 12, wherein the controller is further configured to provide the respective initial flow command to a low pressure valve, the low pressure valve being the one of the first valve and the second valve corresponding to the lower of the first pressure and the second pressure.

14. The hydraulic system of claim 13, wherein the controller is further configured to determine a pressure differential between the first pressure and the second pressure.

15. The hydraulic system of claim 14, wherein the controller is further configured to:
provide the initial flow passing command to the low pressure valve when the pressure differential is greater than a predetermined pressure value; and
alter the initial flow passing command for the low pressure valve when the pressure differential is less that the predetermined pressure value.

16. The hydraulic system of claim 11, further including a first pressure compensating valve disposed between the source and the first valve and a second pressure compensating valve disposed between the source and the second valve, the first and second pressure compensating valves being configured to regulate the flow of pressurized fluid directed from the source to the first valve and the second valve, respectively.

17. A method of controlling a hydraulic system having a first hydraulic circuit and a second hydraulic circuit comprising the steps:
determining a first pressure and first initial flow command associated with the first hydraulic circuit;
determining a second pressure and second initial flow command associated with the second hydraulic circuit;
determining which of the first pressure and the second pressure is a higher pressure; and
altering the initial flow command for a high pressure circuit, the high pressure circuit being the one of the first circuit and the second circuit corresponding to the higher pressure.

18. The method of claim 17 wherein the first hydraulic circuit includes a first valve, the second hydraulic circuit includes a second valve, and the step of altering the initial flow command for the high pressure circuit includes increasing a flow passing area of a high pressure valve, the high pressure valve being the one of the first valve and the second valve corresponding to the high pressure circuit.

19. The method of claim 17, further comprising the step of determining a pressure differential between the first pressure and the second pressure.

20. The method of claim 19, further comprising the step of altering the initial flow command for both the first circuit and the second circuit when the pressure differential is below a predetermined amount.
